(19) United States
(12) Patent Application Publication
(10) Pub. No.: US 2022/0178390 A1
(43) Pub. Date: Jun. 9, 2022

(54) HYDRAULIC ACTUATOR SEALING DEVICE

(71) Applicant: NOK CORPORATION, Tokyo (JP)

(72) Inventors: Daiki KAMO, Fukushima (JP); Kiichiro GOTO, Fukushima (JP)

(21) Appl. No.: 17/604,785

(22) PCT Filed: Mar. 30, 2020
(86) PCT No.: PCT/JP2020/014489

§ 371 Date: Oct. 19, 2021

(30) Foreign Application Priority Data
May 10, 2019 (JP) 2019-089522

(51) Int. Cl. F15B 21/00; F15B 1/26; F15B 15/22

(52) U.S. Cl. CPC F15B 21/00; F15B 15/226; F15B 1/26

(57) ABSTRACT

A hydraulic actuator sealing device includes an annular piston, an annular cancel plate, a return spring, and an annular piston spring seat. The annular piston includes an annular pressure receiving plate portion receiving a load of the return spring, an inner cylinder portion extending from an inner peripheral side of the annular pressure receiving plate portion toward the annular cancel plate, and a bent portion connecting the annular pressure receiving plate portion with the inner cylinder portion and expanding with respect to the annular pressure receiving plate portion in a direction away from the return spring in an axial direction.

### CROSS REFERENCE TO RELATED APPLICATIONS

This application is a U.S. National Phase Application under 35 U.S.C. 371 of International Application No. PCT/JP2020/014489, filed on Mar. 30, 2020, which claims priority to Japanese Patent Application No. 2019-089522, filed on May 10, 2019. The entire disclosures of the above applications are expressly incorporated by reference herein.

### BACKGROUND

### Technical Field

The present invention relates to a hydraulic actuator sealing device.

### Related Art

For example, in a hydraulic actuator that operates a clutch device of an automatic transmission of a vehicle, a sealing device is known that seals between a piston and its outer peripheral side (Japanese Patent Application Publication No. 2006-242311). FIG. 3 is a semi-cross-sectional view showing a conventional hydraulic actuator sealing device, cut by a plane passing through the axis O together with a part of the hydraulic actuator.

As shown in FIG. 3, the hydraulic actuator 100 that operates the clutch device of the automatic transmission of the vehicle is mainly composed of an annular cylinder 101, an annular piston 102, a cancel plate 103, and a return spring 105. The annular cylinder 101 is attached to an unillustrated drive shaft and has a substantially rectangular U-shaped cross section. The annular piston 102 is arranged in the annular cylinder 101 so as to be movable in the axial direction. The cancel plate 103 is arranged opposed to the annular piston 102 in the axial direction and is fixed to the annular cylinder 101 via a snap ring 104. The return spring 105 is interposed between the annular piston 102 and the cancel plate 103 in a compressed state.

An annular piston spring seat 121 is provided between the return spring 105 and the annular piston 102. Further, a cancel plate spring seat 122 is provided between the return spring 105 and the cancel plate 103.

Seal lips 106 and 107 arranged slidably with the annular cylinder 101 are provided at the end portions on the inner peripheral side and outer peripheral side of the annular piston 102, respectively. A seal lip 108 arranged slidably with the annular piston 102 is provided at the end portion on the outer peripheral side of the cancel plate 103. Formed in an inner peripheral cylinder portion 101a of the annular cylinder 101 are an oil passage 101c for introducing hydraulic pressure into a pressure chamber A formed between the annular cylinder 101 and the annular piston 102, and an oil passage 101d facing an equilibrium oil chamber B formed between the annular piston 102 and the cancel plate 103.

The annular piston 102 includes an annular pressure receiving plate portion 102c, an inner cylinder portion 102b extended from the pressure receiving plate portion 102c to the cancel plate 103 side, an inner peripheral flange portion 102a extended from the inner cylinder portion 102b to the inner peripheral cylinder portion 101a side, a bent portion 102g connecting the inner cylinder portion 102b and the pressure receiving plate portion 102c, an outer cylinder portion 102d opposed to the inner cylinder portion 102b in the radial direction, an inclined portion 102e obliquely connecting the pressure receiving plate portion 102c and the outer cylinder portion 102d, and a clutch pressing portion 102f extended outward in the radial direction from the outer cylinder portion 102d.

The hydraulic actuator 100 applies hydraulic pressure with ATF (automatic transmission fluid) to the pressure chamber A via the oil passage 101c, which causes the annular piston 102 to displace in the axial direction inside the annular cylinder 101 in the direction of compressing the return spring 105, bringing a clutch 109 in the connected state.

Meanwhile, when the hydraulic pressure of the pressure chamber A is released from the connected state, the biasing force of the return spring 105 causes the annular piston 102 to displace in the axial direction inside the annular cylinder 101 in the direction of compressing the volume of the pressure chamber A, which releases the frictionally engaged state of the clutch 109.

Here, the bent portion 102g of the annular piston 102 is formed by bending so as to be convex toward the oil passage 101c. In the hydraulic actuator 100, stress tends to concentrate on the bent portion 102g, particularly on the concave surface N of the bent portion 102g. In view of the above, if the curvature of the bent portion 102g is reduced (for example, the radius of curvature is increased) , the concentration of stress on the bent portion 102g can be reduced.

FIG. 4 is a semi-cross-sectional view showing a hydraulic actuator sealing device according to Reference Example, cut by a plane passing through the axis O together with a part of the hydraulic actuator. The hydraulic actuator 100A shown in FIG. 4 is the same as the hydraulic actuator 100 shown in FIG. 3 except for the shape of the bent portion 102g. As shown in FIG. 4, when the curvature of the bent portion 102g is reduced, the annular piston spring seat 121 interferes with the bent portion 102g of the annular piston 102, so that the assemblability is required to be improved.

From this perspective, an object of the present invention is to provide a hydraulic actuator sealing device that can reduce the concentration of stress acting on the annular piston, stabilize the operation of the return spring, and further improve the assemblability.

### SUMMARY

In order to achieve the above object, the present invention is a hydraulic actuator sealing device including an annular cylinder, an annular piston disposed reciprocally in an axial direction in the annular cylinder, an annular cancel plate fixed to the annular cylinder, a return spring interposed between the annular piston and the annular cancel plate, and an annular piston spring seat interposed between the return spring and the annular piston. The hydraulic actuator sealing device has a pressure chamber formed between the annular cylinder and the annular piston and allowing hydraulic pressure to be applied to the pressure chamber, and an equilibrium oil chamber formed between the annular cancel plate and the annular piston. The annular piston includes an annular pressure receiving plate portion receiving a load of the return spring, an inner cylinder portion extending from an inner peripheral side of the annular pressure receiving plate portion toward the annular cancel plate, and a bent portion connecting the annular pressure receiving plate portion with the inner cylinder portion and expanding with respect to the annular pressure receiving plate portion in a direction away from the return spring in the axial direction.

According to the present invention, by expanding the bent portion of the annular piston in the direction away from the return spring in the axial direction, it is possible to avoid interference between the annular piston spring seat and the annular piston. As a result, it is possible to stabilize the operation of the return spring and improve the assemblability. In addition, since the bent portion is expanded in the direction away in the axial direction from the return spring, the curvature of the bent portion can be reduced (for example, the radius of curvature can be increased), so that the concentration of stress acting on the bent portion can be reduced.

In addition, the annular piston spring seat may include a bottom portion receiving the load of the return spring, a protruding portion extending from an inner side of the bottom portion toward the annular cancel plate and located inside the return spring, and a wall portion extending from an outer side of the bottom portion toward the annular cancel plate. The bottom portion may be in contact with the annular pressure receiving plate portion. The wall portion may have an outer surface being in contact with the inner cylinder portion. In this way, the annular piston spring seat is positioned by the annular piston, so that the operation of the return spring can be made more stable.

Further, a cancel plate spring seat interposed between the return spring and the annular cancel plate may be included. In this way, both ends of the return spring are supported by the respective spring seats, so that the operation of the return spring can be made more stable.

### Advantageous Effects of Invention

According to the hydraulic actuator sealing device of the present invention, it is possible to reduce the concentration of stress acting on the annular piston, stabilize the operation of the return spring, and further improve the assemblability.

### BRIEF DESCRIPTION OF THE DRAWINGS

FIG. 1 is a semi-cross-sectional view showing a hydraulic actuator sealing device according to an embodiment, cut by a plane passing through an axis O together with a part of a hydraulic actuator.

FIG. 2 is an enlarged view of a bent portion of an annular piston according to the embodiment.

FIG. 3 is a semi-cross-sectional view showing a conventional hydraulic actuator sealing device, cut by a plane passing through an axis O together with a part of the hydraulic actuator.

FIG. 4 is a semi-cross-sectional view showing a hydraulic actuator sealing device according to Reference Example, cut by a plane passing through the axis O together with a part of the hydraulic actuator.

### DETAILED DESCRIPTION

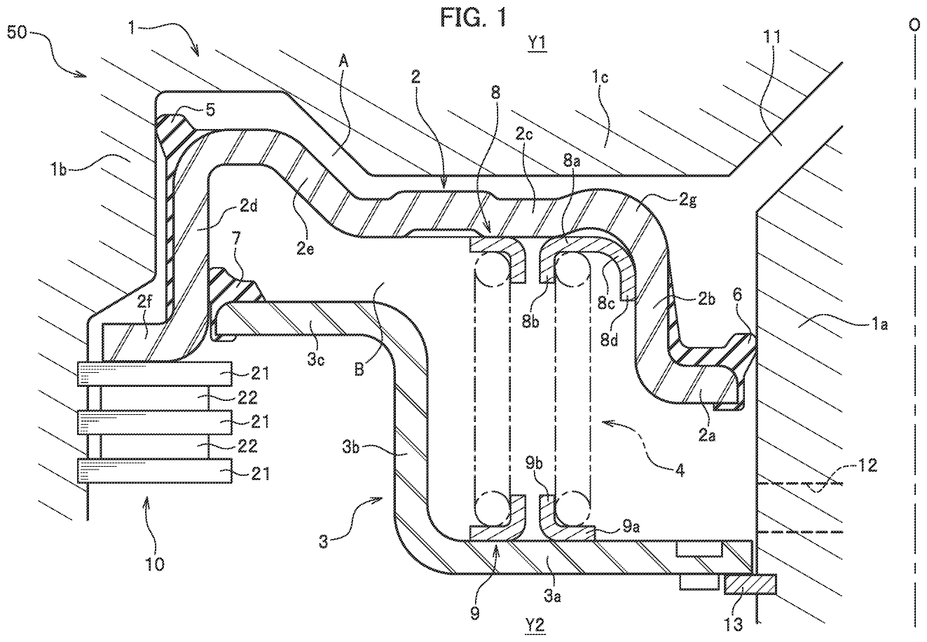

As shown in FIG. 1, a hydraulic actuator sealing device 50 according to the present embodiment seals between a piston and a cylinder in, for example, a hydraulic actuator that operates a clutch device of an automatic transmission of a vehicle.

The hydraulic actuator sealing device 50 is mainly composed of an annular piston 2, a cancel plate 3, a return spring 4, an annular piston spring seat 8, and a cancel plate spring seat 9.

The direction orthogonal to the axis O in FIG. 1 is also referred to as a “radial direction.” The direction parallel to the axis O is also referred to as “axial direction.” Further, the annular piston 2 side is referred to as “one side Y1” and the cancel plate 3 side is referred to as “other side Y2” with respect to the extension and contraction direction of the return spring 4.

The annular piston 2 is an annular member that forms a pressure chamber A into which hydraulic pressure is introduced between the annular piston 2 and the annular cylinder 1. The annular piston 2 is arranged in the annular cylinder 1 so as to be movable in the axial direction. The cancel plate 3 is an annular member that forms an equilibrium oil chamber B between the cancel plate 3 and the annular piston 2. The return spring 4 is a biasing member that is interposed between the annular piston 2 and the cancel plate 3 in a compressed state.

The annular piston spring seat 8 is a member that is interposed between the annular piston 2 and the return spring 4. The cancel plate spring seat 9 is a member that is interposed between the cancel plate 3 and the return spring 4. The annular piston spring seat 8 and the cancel plate spring seat 9 are members that abut on both ends of the return spring 4 and are responsible for the stable operation of extension and contraction of the return spring 4.

The annular piston 2 includes an annular pressure receiving plate portion 2c that receives a load of the return spring 4, an inner cylinder portion 2b that is extended from an inner peripheral side of the pressure receiving plate portion 2c toward the cancel plate 3, and a bent portion 2g that bends and connects the pressure receiving plate portion 2c and the inner cylinder portion 2b. The bent portion 2g is formed so as to expand in a direction away in the axial direction from the return spring 4 with respect to the pressure receiving plate portion 2c, that is, toward the one side Y1.

In the hydraulic actuator sealing device 50, by expanding the bent portion 2g of the annular piston 2 in the direction away in the axial direction from the return spring 4, it is possible to avoid interference between the annular piston spring seat 8 and the annular piston 2. As a result, it is possible to stabilize the operation of the return spring 4 and improve the assemblability. In addition, since the bent portion 2g is expanded in the direction away in the axial direction from the return spring 4, the curvature of the bent portion 2g can be reduced (for example, the radius of curvature can be increased), so that the concentration of stress acting on the bent portion 2g can be reduced. Hereinafter, embodiments will be described in detail.

The annular piston 2 is an annular member manufactured by punching and pressing a metal plate such as a steel plate. The pressure chamber A is formed between the annular cylinder 1 and the annular piston 2. The annular piston 2 is mainly composed of an inner peripheral flange portion 2a, an inner cylinder portion 2b, a pressure receiving plate portion 2c, an outer cylinder portion 2d, an inclined portion 2e, a clutch pressing portion 2f, and a bent portion 2g. The pressure receiving plate portion 2c is a portion that receives the load of the return spring 4, and is formed in an annular shape.

The inner cylinder portion 2b is a portion that is extended in a tubular shape from the inner peripheral side of the pressure receiving plate portion 2c toward the cancel plate 3. The inner cylinder portion 2b has a cylindrical shape concentric with the annular cylinder 1 and is opposed to the outer peripheral surface of an inner peripheral cylinder portion 1a. The inner peripheral flange portion 2a is extended from the end portion on the other side Y2 of the inner cylinder portion 2b toward the axis O. An inner seal lip 6 for the annular piston, made of a rubber-like elastic body, is formed at the end portion of the inner peripheral flange portion 2a so as to be in sliding contact with the inner peripheral cylinder portion 1a of the annular cylinder 1.

The outer cylinder portion 2d is a tubular portion arranged opposed to the inner cylinder portion 2b in the radial direction. The inclined portion 2e is a portion obliquely connecting the pressure receiving plate portion 2c and the outer cylinder portion 2d. The inclined portion 2e is inclined so as to approach an intermediate cylinder portion 1c side of the annular cylinder 1 as it goes toward the outer peripheral side. The clutch pressing portion 2f is a portion that projects from the end portion on the other side Y2 of the outer cylinder portion 2d toward the outer side of the outer cylinder portion 2d. An outer seal lip 5 for the annular piston, made of a rubber-like elastic body, is formed at a bent portion composed of the outer cylinder portion 2d and the inclined portion 2e so as to be in sliding contact with an outer peripheral cylinder portion 1b of the annular cylinder 1. The outer seal lip 5 for the annular piston and the inner seal lip 6 for the annular piston are both attached to the annular piston 2 by cure adhesion.

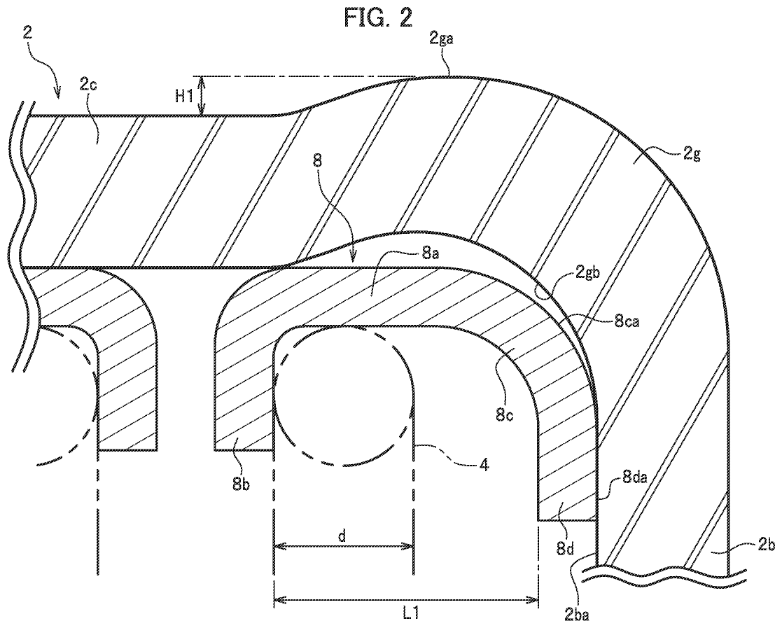

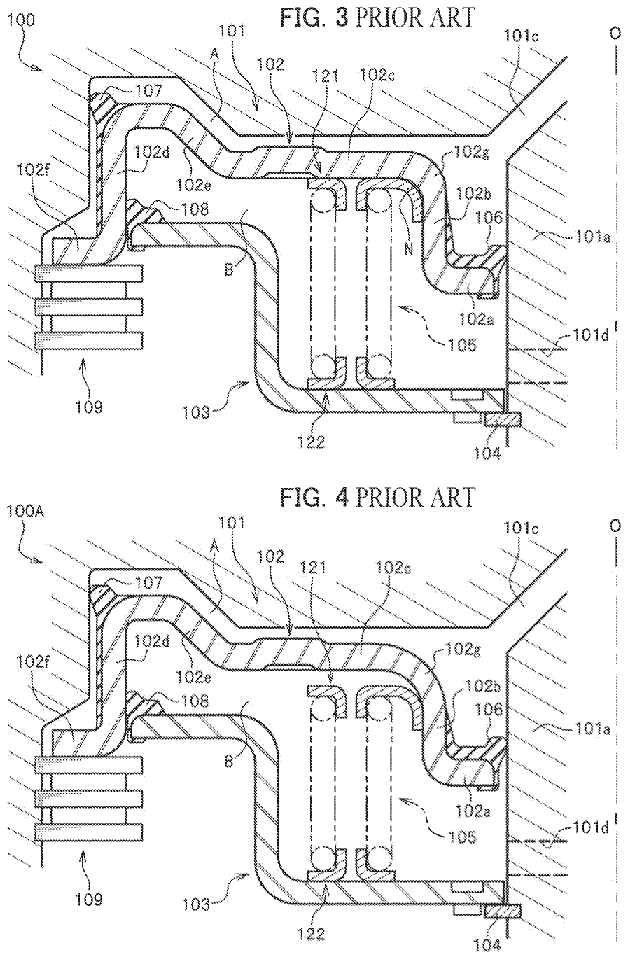

As shown in FIGS. 1 and 2, the bent portion 2g is a portion extending from the end portion on the one side Y1 of the inner cylinder portion 2b to the end portion on the inner peripheral side of the pressure receiving plate portion 2c. The bent portion 2g is formed of a substantially constant-thickness plate, and expands so as to be convex on the one side Y1 (the direction away in the axial direction from the return spring 4 with respect to the pressure receiving plate portion 2c).

The curvature of the bent portion 2g, the plate-thickness of the bent portion 2g, and the expansion height H1 from the pressure receiving plate portion 2c to the outer surface 2ga of the bent portion 2g are set appropriately within a range that can prevent interference between the annular piston 2 and the annular piston spring seat 8 during operation and reduce concentration of stress on the bent portion 2g.

The cancel plate 3 is an annular member manufactured by punching and pressing a metal plate such as a steel plate. The cancel plate 3 is arranged opposed to the annular piston 2. The equilibrium oil chamber B is formed between the annular piston 2 and the cancel plate 3.

The end portion on the inner peripheral side of the cancel plate 3 is fixed to the inner peripheral cylinder portion 1a of the annular cylinder 1 via a snap ring 13. The cancel plate 3 is composed of a pressure receiving plate portion 3a, a tubular portion 3b, and an extension portion 3c. The pressure receiving plate portion 3a is a portion that receives the load of the return spring 4, and is formed in an annular shape.

The tubular portion 3b is a tubular portion that rises from the end portion on the outer side of the pressure receiving plate portion 3a in the radial direction toward the annular piston 2. The extension portion 3c is extended outward in the radial direction from the end portion on the one side Y1 of the tubular portion 3b. An outer seal lip 7 for the cancel plate is formed at the end portion on the outer side in the radial direction of the extension portion 3c so as to be in sliding contact with respect to the displacement in the axial direction of the annular piston 2. The outer seal lip 7 for the cancel plate is formed of a rubber-like elastic body, and is attached to the cancel plate 3 by cure adhesion.

The return spring 4 is a biasing member that is interposed between the annular piston 2 and the cancel plate 3 in a compressed state. The Plurality of return springs 4 are installed in the equilibrium oil chamber B in the circumferential direction of the axis O.

An oil passage 11 for introducing hydraulic pressure into the pressure chamber A is formed between the inner peripheral cylinder portion 1a and the intermediate cylinder portion 1c of the annular cylinder 1. Further, an oil passage 12 facing the equilibrium oil chamber B is formed in the inner peripheral cylinder portion 1a.

The annular piston spring seat 8 is interposed between the annular piston 2 and the return spring 4. The annular piston spring seat 8 is provided for each of the plurality of return springs 4 placed in the circumferential direction. The annular piston spring seat 8 includes a bottom portion 8a, a protruding portion 8b, a bent portion 8c, and a wall portion 8d. The bottom portion 8a has an annular and flat plate shape. As shown in FIG. 2, the bottom portion 8a is in surface contact with the pressure receiving plate portion 2c of the annular piston 2 due to the biasing force of the return spring 4. On the other hand, the bottom portion 8a and the concave surface 2gb of the bent portion 2g of the annular piston 2 are separated from each other.

The protruding portion 8b protrudes in a tubular shape from the inner side of the bottom portion 8a toward the cancel plate 3. An inner peripheral portion of the return spring 4 is fitted to the outer peripheral portion of the protruding portion 8b. The bent portion 8c is a portion that bends and connects the bottom portion 8a and the wall portion 8d. An outer surface 8ca of the bent portion 8c and the concave surface 2gb of the bent portion 2g of the annular piston 2 are separated from each other.

The wall portion 8d is a wall-shaped portion extended from the end portion of the bent portion 8c to the cancel plate 3 side. As shown in FIG. 2, an outer surface 8da of the wall portion 8d is in contact with an outer surface 2ba of the inner cylinder portion 2b of the annular piston 2. The distance L1 from the protruding portion 8b to the wall portion 8d is larger than the wire diameter d of the return spring 4.

As shown in FIG. 1, the cancel plate spring seat 9 is interposed between the cancel plate 3 and the return spring 4. The cancel plate spring seat 9 is provided for each of the plurality of return springs 4 placed in the circumferential direction. The cancel plate spring seat 9 includes a bottom portion 9a and a protruding portion 9b. The bottom portion 9a has an annular and flat plate shape. The bottom portion 9a is in surface contact with the pressure receiving plate portion 3a of the cancel plate 3 due to the biasing force of the return spring 4. The protruding portion 9b protrudes in a tubular shape from the inner side of the bottom portion 9a toward the annular piston 2. An inner peripheral portion of the return spring 4 is fitted to the outer peripheral portion of the protruding portion 9b.

A clutch 10 includes a plurality of drive plates 21 movable in the axial direction and engaged in the circumferential direction on the outer peripheral portion of the annular cylinder 1, and a plurality of driven plates 22 movable in the axial direction and engaged in the circumferential direction on the clutch hub provided on the driven shaft side (both not shown), arranged alternately in the axial direction. The clutch pressing portion 2f formed on the outer peripheral portion of the annular piston 2 is opposed to the clutch 10 in the axial direction.

The hydraulic actuator having the above configuration is designed to apply hydraulic pressure with ATF (automatic transmission fluid) to the pressure chamber A and release this hydraulic pressure, cause the annular piston 2 to displace inside the annular cylinder 1 in the axial direction, and connect or disconnect the clutch 10.

Specifically, when the pressure chamber A is pressurized by the hydraulic pressure of the ATF supplied via the oil passage 11, the annular piston 2 displaces to the other side Y2 in the axial direction while compressing the return spring 4, and the clutch pressing portion 2f of the annular piston 2 presses the drive plates 21 to frictionally engage the driven plates 22. This brings the clutch 10 in the connected state, and the drive torque of the drive shaft is transmitted to the driven shaft (not shown) via the annular cylinder 1, the drive plates 21 and the driven plates 22 of the clutch 10, and the clutch hub.

Further, when the hydraulic pressure of the pressure chamber A is released from this connected state, due to the repulsion of the compressed return spring 4, the annular piston 2 displaces to the one side Y1 in the axial direction so as to reduce the volume of the pressure chamber A, so that the frictional engagement between the drive plates 21 and the driven plates 22 of the clutch 10 is released, and the transmission of the drive torque from the drive shaft to the driven shaft is cut off.

Next, the operations and effects of the actuator sealing device 50 according to the present embodiment will be described. According to the actuator sealing device 50 according to the present embodiment, by expanding the bent portion 2g of the annular piston 2 in the direction away in the axial direction from the return spring 4 with respect to the pressure receiving plate portion 2c, it is possible to avoid interference between the annular piston spring seat 8 and the annular piston 2. More specifically, when the annular piston 2 displaces in the axial direction, the bent portion 8c of the annular piston spring seat 8 does not come into contact with the bent portion 2g of the annular piston 2. Thereby, the operation of the return spring 4 can be stabilized. Further, since the bent portion 8c of the annular piston spring seat 8 does not come into contact with the bent portion 2g of the annular piston 2, it is possible to improve the assemblability of each member including the annular piston 2, the return spring 4, the annular piston spring seat 8, and the like.

In addition, since the bent portion 2g is expanded in the direction away in the axial direction from the return spring 4, the curvature of the bent portion 2g can be reduced (for example, the radius of curvature can be increased), so that the concentration of stress acting on the bent portion 2g can be reduced. In other words, according to the present embodiment, it is possible to eliminate the portion where the curvature of the bent portion 2g becomes large, so that concentration of stress can be avoided.

In addition, in the present embodiment, the bottom portion 8a of the annular piston spring seat 8 is in contact or surface contact with the pressure receiving plate portion 2c of the annular piston 2, and the outer surface 8da of the wall portion 8d is in contact (linear contact) with the outer surface 2ba of the inner cylinder portion 2b of the annular piston 2. In this way, the annular piston spring seat 8 is positioned with respect to the annular piston 2, and the annular piston spring seat 8 becomes difficult to move, so that the operation of the return spring 4 can be made more stable.

Further, in the present embodiment, the operation of the return spring 4 can be more stabilized by providing the annular piston spring seat 8 and the cancel plate spring seat 9 at both ends of the return spring 4, respectively. Also, by fitting the inner peripheral portion of the return spring 4 to the protruding portion 8b of the annular piston spring seat 8 and the protruding portion 9b of the cancel plate spring seat 9, the return spring 4 can be held stably.

Although an example of the embodiment has been described above, the design can be changed as appropriate.

1. A hydraulic actuator sealing device comprising:
an annular cylinder;
an annular piston disposed reciprocally in an axial direction in the annular cylinder;
an annular cancel plate fixed to the annular cylinder;
a return spring interposed between the annular piston and the annular cancel plate; and
an annular piston spring seat interposed between the return spring and the annular piston;
wherein the hydraulic actuator sealing device has:
a pressure chamber formed between the annular cylinder and the annular piston and allowing hydraulic pressure to be applied to the pressure chamber; and
an equilibrium oil chamber formed between the annular cancel plate and the annular piston; and
wherein the annular piston comprises:
an annular pressure receiving plate portion receiving a load of the return spring;
an inner cylinder portion extending from an inner peripheral side of the annular pressure receiving plate portion toward the annular cancel plate; and
a bent portion connecting the annular pressure receiving plate portion with the inner cylinder portion and expanding with respect to the annular pressure receiving plate portion in a direction away from the return spring in the axial direction.

2. The hydraulic actuator sealing device according to claim 1, wherein the annular piston spring seat comprises:
a bottom portion receiving the load of the return spring;
a protruding portion extending from an inner side of the bottom portion toward the annular cancel plate and located inside the return spring; and
a wall portion extending from an outer side of the bottom portion toward the annular cancel plate;
wherein the bottom portion is in contact with the annular pressure receiving plate portion; and
wherein the wall portion has an outer surface in contact with the inner cylinder portion.

3. The hydraulic actuator sealing device according to claim 1, further comprising:
a cancel plate spring seat interposed between the return spring and the annular cancel plate.

4. The hydraulic actuator sealing device according to claim 2, further comprising:
a cancel plate spring seat interposed between the return spring and the annular cancel plate.
